(19) United States
(12) Patent Application Publication
(10) Pub. No.: US 2015/0002290 A1
(43) Pub. Date: Jan. 1, 2015

(54) FIRE CONTROL SYSTEM AND METHOD

(71) Applicant: HON HAI PRECISION INDUSTRY CO., LTD., New Taipei (TW)

(72) Inventors: Shih-Cheng WANG, New Taipei (TW); Yi-Wen CAI, New Taipei (TW)

(73) Assignee: HON HAI PRECISION INDUSTRY CO., LTD., New Taipei (TW)

(21) Appl. No.: 14/138,133

(22) Filed: Dec. 23, 2013

(30) Foreign Application Priority Data
Jun. 28, 2013 (TW) 102123337

(51) Int. Cl. G08B 17/00; G08B 29/04

(52) U.S. Cl. CPC G08B 17/00; G08B 29/043
USPC 340/506

(57) ABSTRACT

An electronic device executes a fire control method. The method transmits a request of acquiring status information of the fire alarm controller to the fire alarm controller. The method further receives the status information from the fire alarm controller and displays the status information on a display screen. When an operation command input by the electronic device is received, the method transmits the received operation command to the fire alarm controller to control the fire alarm controller and/or a plurality of fire equipment.

### BACKGROUND

1. Technical Field

Embodiments of the present disclosure relate to fire alarm technology, and more particularly to a fire control system and method.

2. Description of related art

A fire alarm controller can be used to warn of a fire and control fire equipment. However, a manager who is authorized to operate the fire alarm controller cannot conveniently monitor status of the fire alarm controller using a handheld device. When the fire occurs, the manager needs to rush to the fire alarm controller to operate the fire alarm controller and the fire equipment. The manager may miss an optimal opportunity to extinguish the fire.

### BRIEF DESCRIPTION OF THE DRAWINGS

FIG. 1 is a block diagram of one embodiment of an electronic device including a fire control system.

FIG. 2 is a block diagram of one embodiment of function modules of the fire control system in FIG. 1.

FIG. 3 is a flowchart illustrating one embodiment of a fire control method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

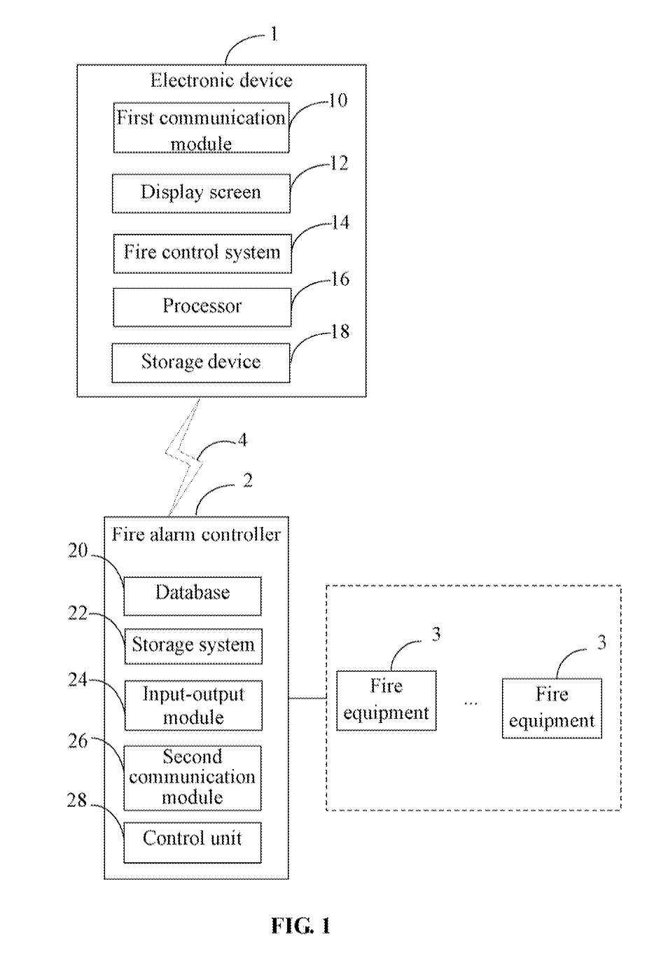

FIG. 1 is a block diagram of one embodiment of an electronic device 1 including a fire control system 14. The electronic device 1 is connected to at least one fire alarm controller 2 (only shown one fire alarm controller 2 in FIG. 1) through a wireless network 4. The wireless network 4 may use wireless communication technology, such as IEEE802.11b (WIFI) technology or a BLUETOOTH wireless communication technology, for example. The electronic device 1 may be a mobile phone, a notebook computer, a personal digital assistant, or any other electronic device.

The electronic device 1 further includes a first communication module 10, a display screen 12, at least one processor 16 and a non-transitory storage device 18. The electronic device 1 communicates with the fire alarm controller 2 through the first communication module 10 and a second communication module 26 in the fire alarm controller 2. Each of the first and second communication modules 10, 26 may be a BLUETOOTH module or a WIFI wireless communication module. The display screen 12 displays various kinds of data of the electronic device 1. The processor 16 executes one or more computerized codes and other applications for the electronic device 1, to provide the functions of the fire control system 14. The storage device 18 is a dedicated memory, such as an EPROM, a hard disk driver (HDD), or flash memory.

The fire alarm controller 2 is a master control device to control plurality of fire equipment 3 that are hardwired communicating or wireless communicating with the fire alarm controller 2. In one embodiment, the fire equipment 3 includes monitoring equipment (e.g., smoke sensors, temperature sensors, and etc.) and alarm equipment. The alarm equipment include indication equipment (e.g. indicator lights) and voice alarm equipment (e.g. alarm sounders). The fire alarm controller 2 further includes a database 20, a storage system 22 and an input-output module 24, and a control unit 28.

The database 20 stores registration information of people who are authorized to control and manage the fire alarm controller 2. The registration information may include, but is not limited to, account names and passwords, for example. The storage system 22 stores current status information of the input-output module 24, and further stores device information and current status information of the fire equipment 3. The status information includes a status representing whether a function (e.g. the buzzing function of a buzzer) of each of the input-output module 4 and the fire equipment 3 is enabled (or powered-on). The device information represents an identification (ID) of each piece of the fire equipment 3.

The input-output module 24 includes a monitoring input module (e.g., camera) and a voice output module (e.g., alarm buzzer) of the fire alarm controller 2. In other embodiment, the input-output module 24 may further include an image output module, such as, a display, for example. The control unit 28 receives operation commands from or transmits the operation commands to the electronic device 1. The control unit 28 can obtain the status information of the input-output module 4 and the fire equipment 3.

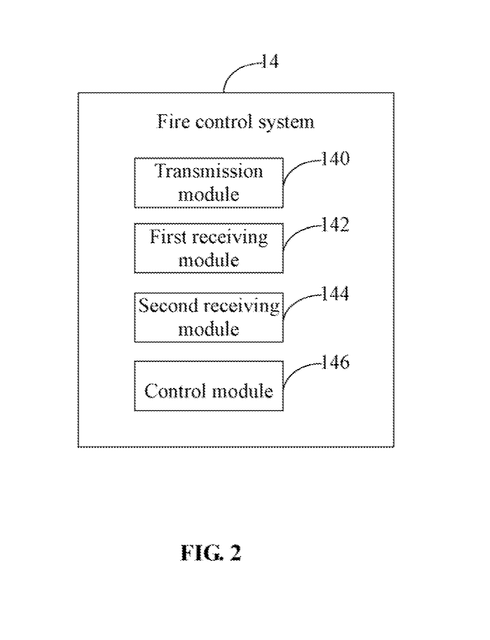

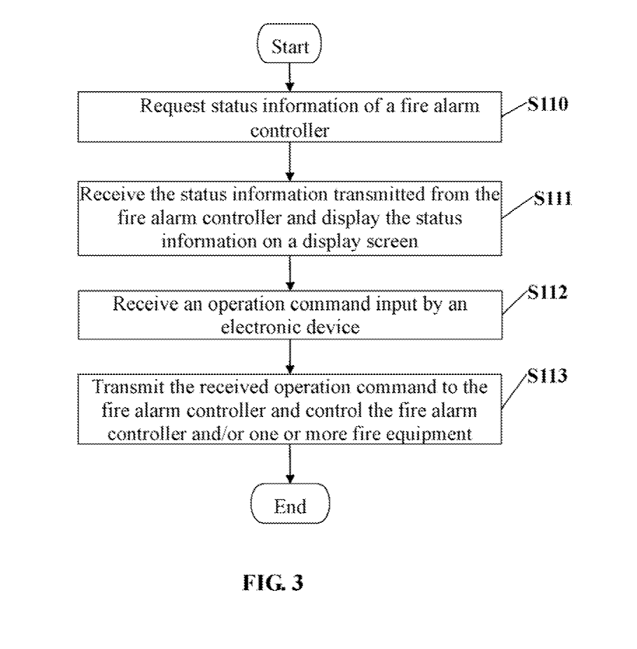

In one embodiment, the operation commands are predefined protocol commands which can be transmitted between the fire alarm controller 2 and the electronic device 1, to control the fire alarm controller 2 and the fire equipment 3. The operation commands may include, but are not limited to a recovery command, an isolation command, and a mute command. The detail functions of the above-mentioned operation commands are described below with reference to FIG. 2-3. In other embodiments, the operation commands may further include a start command of enabling the input-output module 24 and the fire equipment 3, and a close command of disabling the indicator alarm device of the fire equipment 3.

FIG. 2 shows that the fire control system 14 includes a plurality of function modules, such as a transmission module 140, a first receiving module 142, a second receiving module 144, and a control module 146. The modules 140, 142, 144, and 146 include computerized code in the form of one or more programs that are stored in a non-transitory storage device 10 of the electronic device 1. The computerized code includes instructions that are executed by the at least one processor 12 of the electronic device 1 to provide functions of the fire control system 14. Detailed descriptions of the functions of the modules are given below with reference to FIG. 3.

FIG. 3 is a flowchart of one embodiment of a fire control method. Depending on the embodiment, additional steps may be added, others removed, and the ordering of the steps may be changed.

In step S110, when the electronic device 1 is connected to the fire alarm controller 2 successfully, the transmission module 140 requests the file alarm controller 2 to send status information of the fire alarm controller 2. The electronic device 1 connects to the fire alarm controller 2 by transmitting connection information to the fire alarm controller 2. The connection information includes, but is not limited to, an account name, a password, and identification code of the electronic device 1. The identification code represents an identifier, such as an Internet Protocol (IP) address or a BLUETOOTH address, to identify the electronic device 1.

In one embodiment, the fire alarm controller 2 compares the account name and the password transmitted by the electronic device 1 with the registration information stored in the database 20, to determine whether the electronic device 1 is connected to the fire alarm controller 2 successfully. If the account name and the password match one group registration information in the database 20, the fire alarm controller 2 determines that the electronic device 1 is connected to the fire alarm controller 2 successfully. If the account name or the password does not match any group registration information in the database 20, the fire alarm controller 2 determines that the electronic device 1 is not connected to the fire alarm controller 2, that is, the connection of the electronic device 1 is unsuccessfully.

In step S111, the first receiving module 142 receives the status information from the fire alarm controller 2 and displays the status information on the display screen 12. The status information includes a status of each of the monitoring input module, the voice output module in the fire alarm controller 2 and the fire equipment 3. The status information is displayed according to a status bar of each of the monitoring input module, the voice output module and the fire equipment 3. The status bar includes a current status, icons or buttons for invoking different operation commands. Users can use input devices (not shown in FIG. 1) of the electronic device 1 to click or draw an icon or a button in the status bar, to input a corresponding operation command.

In step S112, the second receiving module 144 receives an operation command input by the electronic device 1 in real-time.

In step S113, the control module 146 transmits the received operation command to the fire alarm controller 2 to control the fire alarm controller 2 and/or the fire equipment 3. The received operation command may be the recovery command, the isolation command, and the mute command.

If the recovery command is received, the control module 146 transmits the recovery command to the fire alarm controller 2, and recovers (or restore) the monitoring input modules and the voice output modules to a previous status before alarming, for example, the enabling/disabling of the buzzing function of a buzzer, according to the recovery command. When an isolation command of the monitoring input module or an isolation command of a specified monitoring equipment of the fire equipment 3 is received, the control module 146 transmits the isolation command to the fire alarm controller, and controls the fire alarm controller 2 to disable functions of the monitoring input module or the specified monitoring equipment according to the isolation command. If a mute command of the voice output module or a mute command of a specified voice alarm equipment of the fire equipment 3 is received, the control module 146 transmits the mute command to the fire alarm controller 2, and controls the fire alarm controller 2 to disable functions of the voice output module or the specified voice alarm device according to the mute command.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware.

Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A fire control method being executed by a processor of an electronic device, the electronic device in communication with a fire alarm controller through a wireless network, the method comprising:
requesting status information of the fire alarm controller;
receiving the status information from the fire alarm controller and displaying the status information on a display screen of the electronic device;
receiving an operation command inputted by the electronic device; and
transmitting the received operation command to the fire alarm controller, and controlling the fire alarm controller and/or one or more fire equipment, wherein the one or more fire equipment are electrically connected to the fire alarm controller.

2. The method of claim 1, wherein the status information comprises a status of each of a monitoring input module of the fire alarm controller, a voice output module of the fire alarm controller, and the one or more of fire equipments.

3. The method of claim 2, wherein the operation command is a protocol command predefined between the fire alarm controller and the electronic device, to control the fire alarm controller and the one or more fire equipment; the operation command comprises a recovery command, an isolation command, and a mute command.

4. The method of claim 3, wherein the step of transmitting the received operation command comprises:
transmitting the recovery command to the fire alarm controller, and recovering the monitoring input modules and the voice output modules in the fire alarm controller to a previous status, according to the recovery command.

5. The method of claim 3, wherein the step of transmitting the received operation command comprises:
transmitting the isolation command of the monitoring input module or a specified monitoring equipment of the one or more fire equipment to the fire alarm controller, and controlling the fire alarm controller to disable functions of the monitoring input module or the specified monitoring equipment.

6. The method of claim 3, wherein the step of transmitting the received operation command comprises:
transmitting the mute command of the voice output module or of a specified voice alarm equipment of the one or more fire equipment to the fire alarm controller, and controlling the fire alarm controller to turn off the voice output module or the specified voice alarm equipment.

7. The method of claim 3, wherein the status information is displayed according to a status bar of each of the monitoring input module, the voice output module and the one or more fire equipment, the status bar comprising a current status, icons or buttons for invoking different operation commands.

8. The method of claim 1, wherein the wireless network between the electronic device and the fire alarm controller uses a short distance wireless communication technology.

9. An electronic device in communication with a fire alarm controller through a wireless network, comprising:
at least one processor; and
a storage device storing one or more programs, when executed by the at least one processor, cause the at least one processor to perform operations of:
requesting status information of the fire alarm controller;
receiving the status information transmitted from the fire alarm controller and displaying the status information on a display screen of the electronic device;
receiving operation commands input by the electronic device;
transmitting the received operation command to the fire alarm controller, and controlling at least one of the fire alarm controller and one or more of fire equipment, wherein the one or more fire equipment is electrically connected to the fire alarm controller.

10. The electronic device of claim 9, wherein the status information comprises a status of each of a monitoring input module of the fire alarm controller, a voice output module of the fire alarm controller, and the one or more fire equipment.

11. The electronic device of claim 10, wherein operation command is a protocol command predefined between the fire alarm controller and the electronic device, to control the fire alarm controller and the one or more fire equipment, the operation command comprises a recovery command, an isolation command, and a mute command.

12. The electronic device of claim 11, wherein the operations of transmitting the received operation command comprises:
transmitting the recovery command to the fire alarm controller, and recovering the monitoring input modules and the voice output modules in the fire alarm controller to a previous power-on/off status.

13. The electronic device of claim 11, wherein the operations of transmitting the received operation command comprises:
transmitting the isolation command of the monitoring input module or a specified monitoring equipment of the one or more fire equipment to the fire alarm controller, and controlling the fire alarm controller to disable functions of the monitoring input module or the specified monitoring equipment.

14. The electronic device of claim 11, wherein the operations of transmitting the received operation command comprises:
transmitting the mute command of the voice output module or of a specified voice alarm equipment of the one or more fire equipment to the fire alarm controller, and controlling the fire alarm controller to turn off the voice output module or the specified voice alarm equipment.

15. The electronic device of claim 11, wherein the status information is displayed according to a status bar of each of the monitoring input module, the voice output module and the one or more fire equipment, the status bar comprising a current status, icons or buttons for invoking different operation commands.

16. The electronic device of claim 9, wherein the wireless network between the electronic device and the fire alarm controller uses a short distance wireless communication technology.

17. A non-transitory computer-readable medium having stored thereon instructions that, when executed by at least one processor of an electronic device, the electronic device in communication with a fire alarm controller through a wireless network, cause the at least one processor to perform operations of:
requesting status information of the fire alarm controller;
receiving the status information transmitted from the fire alarm controller and displaying the status information on a display screen of the electronic device;
receiving operation commands input by the electronic device;
transmitting the received operation command to the fire alarm controller, and controlling at least one of the fire alarm controller and one or more of fire equipment, wherein the one or more of fire equipment are electrically connected to the fire alarm controller.

18. The medium of claim 17, wherein the status information comprises a status of each of a monitoring input module of the fire alarm controller, a voice output module of the fire alarm controller, and the one or more fire equipment.

19. The medium of claim 18, wherein operation command is a protocol command predefined between the fire alarm controller and the electronic device, to control the fire alarm controller and the one or more fire equipment, the operation command comprises a recovery command, an isolation command, and a mute command.
